(19) United States
(12) Patent Application Publication
(10) Pub. No.: US 2026/0044935 A1
(43) Pub. Date: Feb. 12, 2026

(54) HIGH-RESOLUTION PET-CT IMAGING USING PCCT AND ADVANCED GENERATIVE MODELS

(71) Applicant: Siemens Medical Solutions USA, Inc., Malvern, PA (US)

(72) Inventors: Pooyan Sahbaee, Bethesda, MD (US); James O Doherty, Johns Island, SC (US); Deepak Bharkhada, Knoxville, TN (US)

(21) Appl. No.: 18/959,741

(22) Filed: Nov. 26, 2024

Related U.S. Application Data
(60) Provisional application No. 63/679,674, filed on Aug. 6, 2024.

(51) Int. Cl. G06T 5/50; G06T 3/4046; G06T 3/4053; G06T 5/60

(52) U.S. Cl. CPC G06T 5/50; G06T 3/4046; G06T 3/4053; G06T 5/60; G06T 2207/10104; G06T 2207/20081; G06T 2207/20084; G06T 2207/20221; G06T 2207/30004

(57) ABSTRACT

Systems and methods for using paired high-resolution photon counting CT (PCCT) and PET images from the same patient to generate high-resolution PET images. A machine learning network is trained on paired images from patients. When the trained model is applied, a new patient's PET and PCCT images may be used to generate a high-resolution PET image for a medical diagnosis or further processing.

### CROSS REFERENCE TO RELATED APPLICATIONS

This application claims the benefit of the filing date under 35 U.S.C. § 119(e) of Provisional U.S. patent application Ser. No. 63/679,674, filed Aug. 6, 2024, which is hereby incorporated by reference.

### FIELD

This disclosure relates to medical imaging.

### BACKGROUND

A positron emission tomography (PET) scan is a type of imaging test. It uses a radioactive substance called a tracer to look for disease in the body. PET imaging, while excellent for functional imaging of metabolic processes, suffers from inherently lower spatial resolution compared to computed tomography (CT) imaging. This discrepancy can limit the diagnostic utility of PET/CT images, especially in detecting small lesions or providing detailed anatomical context to metabolic activity. Higher resolution could definitely translate into several clinical and diagnostic advantages.

Until now, this problem has been approached through various image reconstruction techniques and hardware improvements. For instance, the xSPECT technique combines SPECT and CT data to enhance the spatial resolution of SPECT images by leveraging the higher resolution of CT images through conventional reconstruction methods. However, these approaches have limitations, including the potential for introducing artifacts or the requirement for specific hardware configurations.

### SUMMARY

By way of introduction, the preferred embodiments described below include methods, systems, instructions, and/or computer readable media leveraging the high resolution of a CT image to enhance the resolution of a corresponding PET image from the same patient using advanced generative models. The Generative models may include, for example, conditional Diffusion Models that excel due to their ability to generate high-quality, detailed outputs guided by the high-resolution CT/PCCT data. CycleGAN, Pix2PixHD and similar Conditional GANs offer robust paired image-to-image translation, efficiently leveraging the complementary nature of PET and CT/PCCT data. Attention-UNet and TransUNet architectures combine multi-modal inputs effectively, preserving spatial details from CT/PCCT while enhancing PET features. Meanwhile, Multi-Modal Variational Autoencoders (MM-VAE) and Fusion Models enable probabilistic and structural fusion of PET and CT/PCCT, generating either high-res PET or infused PET-CT/PCCT outputs. Neural Radiance Fields (NeRF), though less commonly applied, can be adapted for fine-detail reconstruction using CT/PCCT priors, highlighting the substantial resolution gap between PET and CT/PCCT and the need for such advanced methodologies.

In a first aspect, a system for generation of high-res PET images from paired CT and PCCT images, the system comprising: a medical imaging device configured to acquire a PET image of a region of a patient and a PCCT image of the region of the patient; a processing unit configured to input the PET image and the PCCT image into a machine learning network trained to generate high resolution PET-CT images that comprise a higher resolution than input PET images; and a display configured to display a high resolution PET-CT image generated from the PET image and the PCCT image.

In a second aspect, a method for generation of high-resolution PET images, the method comprising: acquiring, by a medical imaging device, a PET image of a region of a patient; acquiring, by the medical imaging device, a PCCT image of the region of the patient; inputting the PET image and the PCCT image into a machine learning network, the machine learning network trained to output high resolution PET images that comprise a higher resolution than input PET images; and outputting a high-resolution PET image of the region of the patient.

In a third aspect, a method for generation of fused high-res PET image from paired CT and PCCT images, the method comprising: acquiring, by a medical imaging device, a PET image of a region of a patient; acquiring, by the medical imaging device, a PCCT image of the region of the patient; inputting the PET image and the PCCT image into a machine learning network, the machine learning network trained to output high resolution PET-CT images that comprise a higher resolution than input PET images; and outputting a high-resolution fused PET-CT image of the region of the patient.

Any one or more of the aspects described above may be used alone or in combination. These and other aspects, features and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views. The patent or application file contains at least one drawing executed in color. Copies of this patent or patent application publication with color drawing(s) will be provided by the Office upon request and payment of the necessary fee.

FIG. 1 depicts an example system for using paired high-resolution photon counting CT (PCCT) and PET images from the same patient to generate high-resolution PET images according to an embodiment.

FIG. 2 depicts an example PET/PCCT imaging device for using paired high-resolution photon counting CT (PCCT) and PET images from the same patient to generate high-resolution PET images according to an embodiment.

FIG. 3 depicts an example machine learning network.

FIG. 4 depicts an example convolutional neural network (CNN).

FIG. 5 depicts an example generative adversarial network (GAN) according to an embodiment.

FIG. 6 depicts an example CycleGAN for using paired high-resolution photon counting CT (PCCT) and PET images from the same patient to generate high-resolution PET images according to an embodiment.

FIGS. 7A and 7B depict example CNN for using paired high-resolution photon counting CT (PCCT) and PET images from the same patient to generate high-resolution PET images according to an embodiment.

FIG. 8 depicts an example autoencoder network for using paired high-resolution photon counting CT (PCCT) and PET images from the same patient to generate high-resolution PET images according to an embodiment.

FIG. 9 depicts an example network with transformers for using paired high-resolution photon counting CT (PCCT) and PET images from the same patient to generate high-resolution PET images according to an embodiment.

FIG. 10 depicts an example method for using paired high-resolution photon counting CT (PCCT) and PET images from the same patient to generate high-resolution fused PET/CT images according to an embodiment.

FIG. 11 depicts an example for using paired high-resolution photon counting CT (PCCT) and PET images from the same patient to generate high-resolution PET images according to an embodiment.

### DETAILED DESCRIPTION

Embodiments described herein provide systems and methods for using paired high-resolution photon counting CT (PCCT) and PET images from the same patient to generate high-resolution PET images. A machine learning network/model is trained on paired images from patients. When the trained model is applied, new patient's PET and PCCT images may be used to generate a high-resolution PET image for a medical diagnosis or further processing.

Positron emission tomography (PET) is a type of nuclear medicine procedure that measures metabolic activity of the cells of body tissues. PET differs from other nuclear medicine examinations in that PET detects metabolism within body tissues, whereas other types of nuclear medicine examinations detect the amount of a radioactive substance collected in body tissue in a certain location to examine the tissue's function. PET may also be used in conjunction with other diagnostic tests, such as computed tomography (CT) or magnetic resonance imaging (MRI) to provide more definitive information, for example about tumors and other lesions. Newer technology combines PET and CT into one scanner, known as a PET/CT scanner which can perform both scans on a patient during an imaging session. PET scanners for clinical use typical have spatial-resolutions of around 4-5 mm. This low resolution is caused by detector sizes, free path of positrons, and non-collinearity uncertainty of annihilation photon-pairs. The drawback in resolution significantly restrains the sensitivity of PET in imaging small lesions, for example early-stage cancers or small metastasis. In addition, a clinical PET scan typically takes 15-20 minutes. Potential imaging using various techniques to provide high spatial resolution may require extended scan time which may be inefficient and unfeasible.

Photon-counting computed tomography (PCCT) is an advanced CT imaging technique. Conventional CT devices use energy-integrating detectors (EIDs) equipped with scintillator elements and reflective layers. A layer of scintillators elements converts the incident X-ray photons into low energy secondary photons in the visible spectrum. These photons are then absorbed by a photodiode array made of a semiconducting material, which generates an electrical signal proportional to the total deposited energy, summed to electronic thermal noise. Finally, the electrical signal is amplified and then converted to a digital signal, so that it can be processed for tomographic image reconstruction. As opposed to typical CT imaging, in PCCT, photon-counting detectors resolve the number of photons and the incident X-ray energy spectrum into multiple energy bins. Compared with conventional CT technology, PCCT offers an advantages of improved spatial and contrast resolution, reduction of image noise and artifacts, reduced radiation exposure, and multi-energy/multi-parametric imaging based on the atomic properties of tissues, with the consequent possibility to use different contrast agents and improve quantitative imaging.

Embodiments described herein integrate the use of PCCT imaging, which offers superior resolution (up to 0.11 mm) and sensitivity, with PET imaging. In an alternative embodiment, CT images with a high resolution may be used. The resulting images improve the resolution of the PET image, thereby enhancing disease detection, staging, and treatment monitoring.

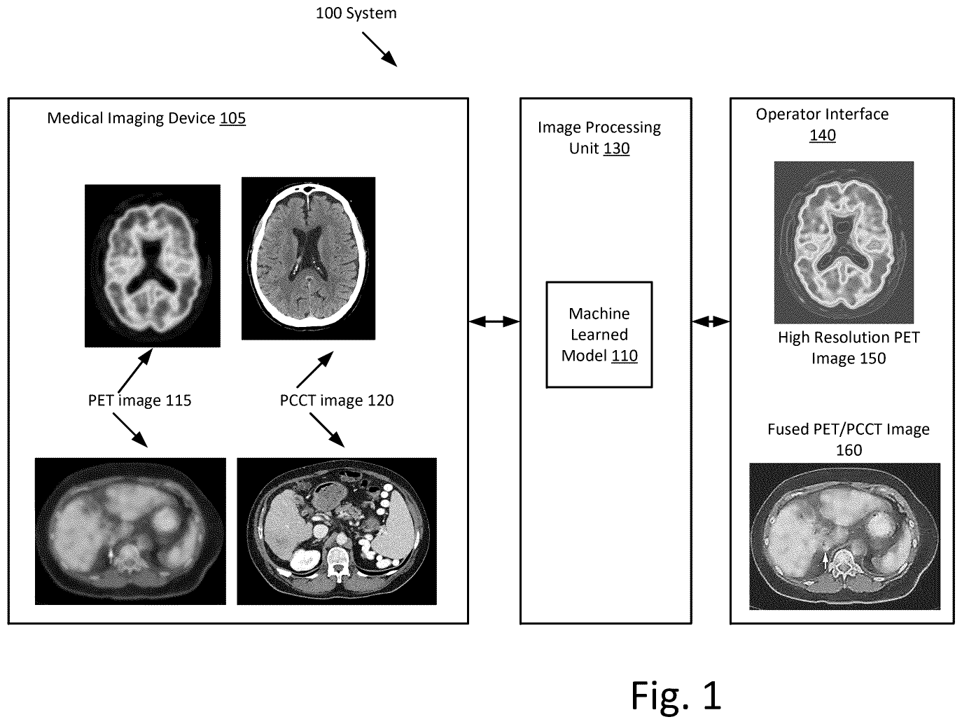

FIG. 1 depicts a system for using paired high-resolution photon counting CT (PCCT) 120 and PET images 115 from the same patient to generate high-resolution PET images. Images are acquired from the same patient to ensure accuracy and alignment. While the same model could be used to generate synthetic high-res PET or PET-CT images, these synthetic outputs would not represent real patient data. The system includes a medical imaging device 105, an image processing unit 130, and an operator interface 140. Fewer or more devices may be included or excluded. For example, the medical imaging device 105 may not be used if real patient images are acquired from other sources, such as a medical imaging database. The image processing unit 130 is configured to generate high-resolution PET images 150 and/or fused images 160 using a machine learning network 110 from paired PCCT and PET images 115 of a patient 225. The medical imaging device 105 may be used to acquire real patient images for training the model. FIG. 1 depicts two example of generating high-resolution PET images. The first example depicts generating a high resolution PET image 150 from a PET image 115 and a PCCT image 120 of a patient 225 acquired during a single session. The second example depicts generating a fused PET/PCCT image 160 from a PET image 115 and a PCCT image 120 of a patient 225 acquired during a single session. The output images may be part of or included with the xSPECT system. By using the CT as the frame-of-reference for image reconstruction, the xSPECT system may extract a zone map with different tissue segments to delineate the boundaries of the nuclear uptake during SPECT reconstruction.

The operator interface 140 includes an input device and an output device. The input may be an interface, such as interfacing with a computer network, memory, database, medical image storage, or other source of input data. The input may be a user input device, such as a mouse, trackpad, keyboard, roller ball, touch pad, touch screen, or another apparatus for receiving user input. The output is a display device but may be an interface. The original images, fused images, and/or higher resolution images from the scan are displayed. For example, a high resolution image of a region of the patient 225 is displayed. The display is a CRT, LCD, plasma, projector, printer, or other display device. The display is configured by loading an image to a display plane or buffer. The display is configured to display the image of the region of the patient 225. The operator interface may include a graphical user interface (GUI) enabling user interaction with the medical imaging device 105 and enables user modification or selections in substantially real time.

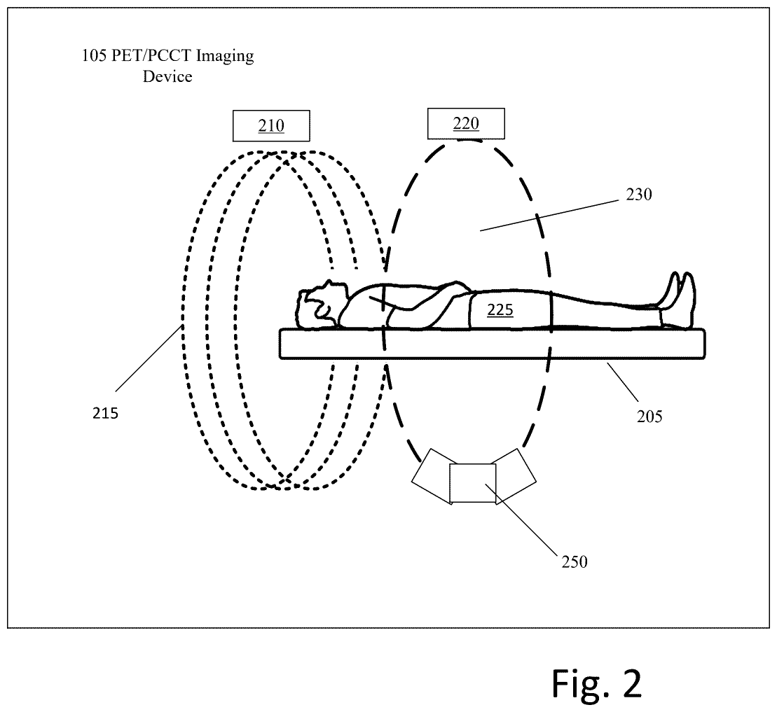

The system includes a medical imaging device 105 (PET/PCCT imaging device) that is configured with both PET and PCCT positron emission tomography/CT (PET/CT) units so that the medical imaging device 105 can perform both exams at the same time, for example during the same imaging session. The PCCT system 220 is within a same housing as the PET system 210. Alternatively, in an embodiment, the PET and PCCT scanners may be separate devices but still acquire images from the same patient at different time points. FIG. 2 depicts an example medical imaging device 105 that is configured to acquire both PET and PCCT data. The medical imaging device 105 is only exemplary, and a variety of CT scanning systems may be used to collect the PCCT data and PET data with different configurations. In the medical imaging device 105 of FIG. 2, an object 225 (e.g., a patient 225) is positioned on a table 205 that is configured, via a motorized system, to move the table to multiple positions through a circular opening 230 in the PET/PCCT scanner. An X-ray source (or other radiation source) and detector element(s) 250 are a part of the PET/PCCT scanner and are configured to rotate around the subject 225 on a gantry while the subject is inside the opening/bore 230. The rotation may be combined with movement of the bed 205 to scan along a longitudinal extent of the patient 225. Alternatively, the gantry moves the source and detectors 250 in a helical path about the patient 225. In a PET/PCCT scanner, a single rotation may take approximately one second or less. During the rotation of the X-ray source and/or detector, the X-ray source produces a narrow, fan-shaped (or cone-shaped) beam of X-rays that pass through a targeted section of the body of the subject 225 being imaged. The detector element(s) 250 are opposite the X-ray source and register the X-rays that pass through the body of the subject 225 being imaged and, in that process, record a snapshot used to reconstruct an image. Many different snapshots at many angles through the subject are collected through one or more rotations of the X-ray source and/or detector element(s) 250. The data generated by the collected snapshots are transmitted to the image processing unit 130 that stores or processes the acquired data based on the snapshots into one or several cross-sectional images or volumes of an interior of the body (e.g., internal organs or tissues) of the subject being scanned by the PET/PCCT scanner. Any now known or later developed PET/PCCT scanner may be used. Other x-ray scanners, such as a CT-like C-arm scanner, may be used.

Conventional medical CT systems are equipped with solid-state scintillation detector elements (such as energy-integrating detectors (EIDs). In a two-step conversion process, the absorbed X-rays are first converted into visible light in the scintillation crystal. The light is then converted into an electrical signal by a photodiode attached to the backside of each detector cell. PCCT utilizes a direct conversion X-ray detector where incident X-ray photon energies are directly recorded as electronical signals. Photon Counting Detectors (PCDs) directly convert deposited X-ray energy to an electronic signal, as a large voltage is applied across the semiconductor, creating electron hole pairs when a photon hits the detector. By using energy-resolving detectors instead of EIDs, PCCT systems are able to count individual incoming x-ray photons and measure their energy. The energy information may then be used for generating an image and other tasks such as material decomposition. For material decomposition, energy-selective images are generated from the number of registered counts in each energy bin. From these images, a set of material concentration maps is generated through a data-processing method known as material decomposition. Material concentration maps may be used in generating an image but also assisting in augmenting the simulated ultrasound data with fine tissue data.

In current clinical EIDs the pixel size is about 0.4-0.6 mm at the isocenter, limiting their resolution. In fact, the design of smaller detector pixels causes an increase in the relative area to the septum in comparison to the detector area, with a consequent reduction in the geometric dose efficiency. In PCDs, thanks to the absence of a mechanic separation, the pixel pitch does not have a technical limitation and can reach 0.15-0.225 mm at the isocenter. The PCCT data acquired by the PCDs is transmitted to the image processing unit 130 which generates an PCCT image 120 and/or PCCT image data.

The PET data is acquired using a PET scan performed by the PET/PCCT scanner. The spatial resolution of a PET image is typically 4-5 mm. The inherent resolution of a PET image is much than that of a CT/PCCT image. By using a CT/PCCT image from the same patient, the resolution of the PET image may be improved. The PET scan provides data relating to the metabolic or biochemical function of the tissues and organs of the imaged patient 225. The PET scan may use a radioactive drug referred to as a tracer to show both typical and atypical metabolic activity. The PET system 210 includes a plurality of detectors such as crystals or other photon detectors. For example, the detectors are scintillation crystals coupled to avalanche photo diodes. In other embodiments, scintillation crystals are coupled with photomultiplier tubes. The scintillation crystals are bismuth germanium oxide, gadolinium oxyorthosilicate, or lutetium oxyorthosilicate crystals, but other crystals may be used. Solid-state or semiconductor detectors may be used.

The detectors 215 are arranged individually or in groups. Blocks or groups of detectors are arranged in any pattern around the bore, for example a ring. The rings of detectors 215 are spaced apart but are placed adjacent or abutting each other. Any gap may be provided between blocks within a ring, detectors within a block, and/or between rings. Any number of detectors in a block, detector blocks in a ring, and/or rings may be used. The rings may extend completely or only partially around the bore.

The PET system 210 is a nuclear imaging system. The detectors detect gamma rays emitted indirectly by a positron-emitting tracer. Pairs of gamma rays generated by a same positron may be detected using the ring of the detectors. The pairs of gamma rays travel about 180 degrees apart. If the direction of travel intersects the arrangement of detectors at two locations, a coincident pair may be detected. To distinguish specific pairs, the coincidence of detected gamma rays is determined. The timing of receipt is used to pair the detected gamma rays. The timing, as prompt data, may also indicate the time-of-flight, providing information generally about where along a line of response the emission occurred. Each individual detection output from the detectors includes energy, position, and timing information. Alternatively, the detectors output energy information and a receiving processor determines the timing and position (e.g., based on port assignment or connections). The timing information is used to determine coincidence of detection by different detectors by the coincidence processors as well as general position along the line of response of the emission. Pairs of gamma rays associated with a same positron emission are determined. Based on the detected event, a line-of-response is determined given the detectors involved in the detection of that event. The detected events are transmitted to the image processing unit 130 which generates PET image data.

Alternatively, the systems and methods described herein may be applied to any PET images 115 with paired high-res CT images from the same patient 225 that are acquired using PET-PCCT systems, PET-CT systems, and/or PET and CT scanners.

The image processing unit 130/controller may include an image processor that generates the fused image and/or higher resolution image using a machine learning network 110 (machine learning model 110). The image processor is a general processor, digital signal processor, three-dimensional data processor, graphics processing unit, application specific integrated circuit, field programmable gate array, artificial intelligence processor, digital circuit, analog circuit, combinations thereof, or another now known or later developed device for image generation. The image processor is a single device, a plurality of devices, or a network. For more than one device, parallel or sequential division of processing may be used. Different devices making up the image processor may perform different functions. In one embodiment, the image processor is also a control processor or other processor of the PET/PCCT imaging device. Other image processors of the PET/PCCT imaging device or external to the PET/PCCT imaging device may be used. The image processor is configured by software, firmware, and/or hardware to process the data acquired by the PET/PCCT imaging device and output one or more images. The image processor may reconstruct intermediate images from the data from the PET/PCCT imaging device and then fuse or upscale the images using a machine learning network 110 in order to provide a higher resolution/more detailed image. The instructions for implementing the processes, methods, and/or techniques discussed herein are provided on non-transitory computer-readable storage media or memories, such as a cache, buffer, RAM, removable media, hard drive, or other computer readable storage media. The instructions are executable by the processor or another processor. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the instructions set, storage media, processor or processing strategy and may be performed by software, hardware, integrated circuits, firmware, micro code, and the like, operating alone or in combination. In one embodiment, the instructions are stored on a removable media device for reading by local or remote systems. In other embodiments, the instructions are stored in a remote location for transfer through a computer network. In yet other embodiments, the instructions are stored within a given computer, CPU, GPU, or system. Because some of the constituent system components and method steps depicted in the accompanying figures may be implemented in software, the actual connections between the system components (or the process steps) may differ depending upon the manner in which the present embodiments are programmed.

In general, a trained machine learning network mimics cognitive functions that humans associate with other human minds. In particular, by training based on training data the machine learning network is able to adapt to new circumstances and to detect and extrapolate patterns. Another term for “trained machine learning network” is “trained function”. In general, parameters of a machine learning network can be adapted by means of training. In particular, supervised training, semi-supervised training, unsupervised training, reinforcement learning and/or active learning can be used. Furthermore, representation learning (an alternative term is “feature learning”) can be used. In particular, the parameters of the machine learning networks can be adapted iteratively by several steps of training. In particular, within the training a certain cost function can be minimized. In particular, within the training of a neural network the backpropagation algorithm can be used. In particular, a machine learning network may comprise a neural network, a support vector machine, a decision tree and/or a Bayesian network, and/or the machine learning network can be based on k-means clustering, Q-learning, genetic algorithms and/or association rules. In particular, a neural network can be a deep neural network, a convolutional neural network or a convolutional deep neural network. Furthermore, a neural network can be an adversarial network, a deep adversarial network and/or a generative adversarial network.

In an embodiment, the machine learning network 110 may be provided by or implemented with a neural network trained using deep learning. Each of the trained networks may be defined as a plurality of sequential feature units or layers. Sequential is used to indicate the general flow of output feature values from one layer to input to a next layer. The information from the next layer is fed to a next layer, and so on until the final output. The layers may only feed forward or may be bi-directional, including some feedback to a previous layer. The nodes of each layer or unit may connect with all or only a sub-set of nodes of a previous and/or subsequent layer or unit. Skip connections may be used, such as a layer outputting to the sequentially next layer as well as other layers. Rather than pre-programming the features and trying to relate the features to attributes, the deep architecture is defined to learn the features at different levels of abstraction the input data. The features are learned to reconstruct lower level features (i.e., features at a more abstract or compressed level). For example, features for generating a fused image or higher resolution image are learned. For a next unit, features for reconstructing the features of the previous unit are learned, providing more abstraction. Each node of the unit represents a feature. Different units are provided for learning different features.

Various units or layers may be used, such as convolutional, pooling (e.g., max-pooling), deconvolutional, fully connected, or other types of layers. Within a unit or layer, any number of nodes is provided. For example, 100 nodes are provided. Later or subsequent units may have more, fewer, or the same number of nodes. In general, for convolution, subsequent units have more abstraction. For example, the first unit provides features from the image, such as one node or feature being a line found in the image. The next unit combines lines, so that one of the nodes is a corner. The next unit may combine features (e.g., the corner and length of lines) from a previous unit so that the node provides a shape indication. For transposed-convolution to reconstruct, the level of abstraction reverses. Each unit or layer reduces the level of abstraction or compression.

Unlike conventional methods that primarily rely on mathematical models and hardware improvements for resolution enhancement, embodiments utilize advanced machine learning techniques to directly learn from data how to improve image quality. This method can be applied to existing PET/PCCT datasets without the need for additional hardware. By training with real high-resolution PCCT 120 and PET images 115, the generated high-resolution PET images are both accurate and realistic, potentially reducing artifacts common in conventional methods. The process may also be more efficient in terms of both time and computational resources compared to traditional reconstruction techniques, as it leverages the power of AI for image processing. In an embodiment, utilizing GANs for PET/CT image enhancement represents an innovative use of machine learning in medical imaging. This approach can continuously improve as more data becomes available and models are further refined, unlike static mathematical models used in traditional methods.

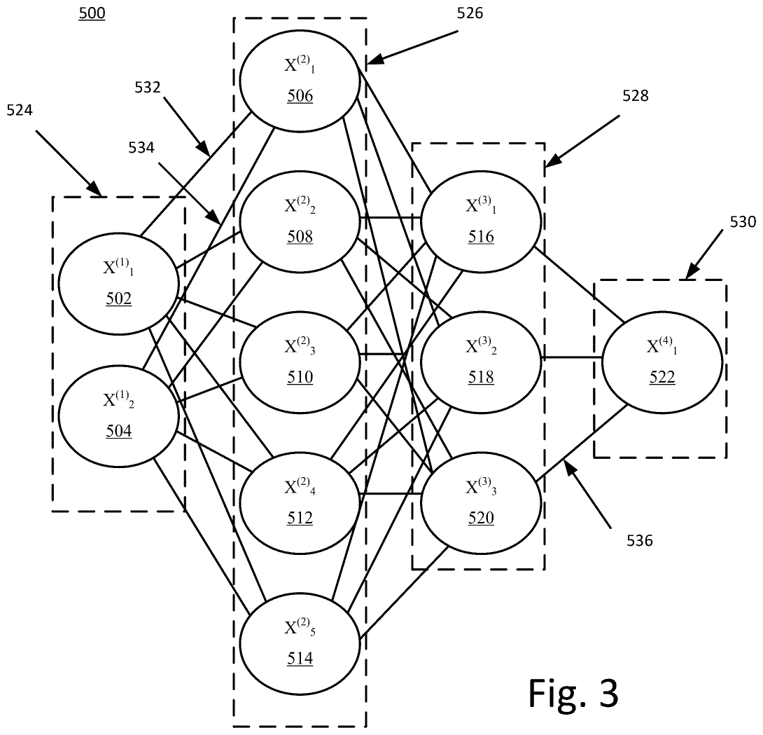

FIG. 3 shows an embodiment of an artificial neural network 500, in accordance with one or more embodiments. Alternative terms for “artificial neural network” are “neural network”, “artificial neural net” or “neural net”. The artificial neural network 500 may be used in part in, for example, the one or more machine learning based networks utilized for in the GAN, the autoencoder, the CNN, the unrolled networks, etc.

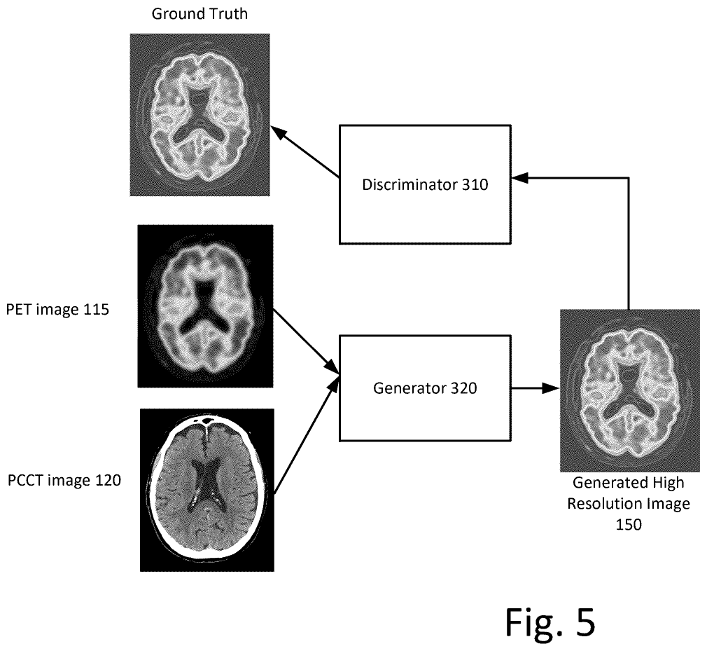

The artificial neural network 500 includes nodes 502-522 and edges 532, 534, . . . , 536, wherein each edge 532, 534, . . . , 536 is a directed connection from a first node 502-522 to a second node 502-522. In general, the first node 502-522 and the second node 502-522 are different nodes 502-522, it is also possible that the first node 502-522 and the second node 502-522 are identical. For example, in FIG. 5, the edge 532 is a directed connection from the node 502 to the node 506, and the edge 534 is a directed connection from the node 504 to the node 506. An edge 532, 534, . . . , 536 from a first node 502-522 to a second node 502-522 is also denoted as “ingoing edge” for the second node 502-522 and as “outgoing edge” for the first node 502-522.

In this embodiment, the nodes 502-522 of the artificial neural network 500 may be arranged in layers 524-530, wherein the layers may include an intrinsic order introduced by the edges 532, 534, . . . , 536 between the nodes 502-522. In particular, edges 532, 534, . . . , 536 may exist only between neighboring layers of nodes. In the embodiment shown in FIG. 5, there is an input layer 524 including only nodes 502 and 504 without an incoming edge, an output layer 530 including only node 522 without outgoing edges, and hidden layers 526, 528 in-between the input layer 524 and the output layer 530. In general, the number of hidden layers 526, 528 may be chosen arbitrarily. The number of nodes 502 and 504 within the input layer 524 usually relates to the number of input values of the neural network 500, and the number of nodes 522 within the output layer 530 usually relates to the number of output values of the neural network 500.

In particular, a (real) number may be assigned as a value to every node 502-522 of the neural network 500. Here, x (n); denotes the value of the i-th node 502-522 of the n-th layer 524-530. The values of the nodes 502-522 of the input layer 524 are equivalent to the input values of the neural network 500, the value of the node 522 of the output layer 530 is equivalent to the output value of the neural network 500. Furthermore, each edge 532, 534, . . . , 536 may include a weight being a real number, in particular, the weight is a real number within the interval [−1, 1] or within the interval [0, 1]. Here, w^{(m,n)}_{i,j} denotes the weight of the edge between the i-th node 502-522 of the m-th layer 524-530 and the j-th node 502-522 of the n-th layer 524-530. Furthermore, the abbreviation w⁽ⁿ⁾_{i,j} is defined for the weight w^{(n,n+1)}_{i,j}.

In particular, to calculate the output values of the neural network 500, the input values are propagated through the neural network. In particular, the values of the nodes 502-522 of the (n+1)-th layer 524-530 may be calculated based on the values of the nodes 502-522 of the n-th layer 524-530 by

$${x}_{j}^{( n + 1 )} = f ( {\sum }_{i} {x}_{i}^{( n )} \cdot {w}_{i , j}^{( n )} ) .$$

Herein, the function f is a transfer function (another term is “activation function”). Known transfer functions are step functions, sigmoid function (e.g. the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 524 are given by the input of the neural network 500, wherein values of the first hidden layer 526 may be calculated based on the values of the input layer 524 of the neural network, wherein values of the second hidden layer 528 may be calculated based in the values of the first hidden layer 526, etc.

In order to set the values w^{(m,n)}_{i,j} for the edges, the neural network 500 has to be trained using training data. In particular, training data includes training input data and training output data (denoted as tᵢ). For a training step, the neural network 500 is applied to the training input data to generate calculated output data. In particular, the training data and the calculated output data include a number of values, said number being equal with the number of nodes of the output layer.

In particular, a comparison between the calculated output data and the training data is used to recursively adapt the weights within the neural network 500 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δ⁽ⁿ⁾ⱼ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δ⁽ⁿ⁺¹⁾ⱼ, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 530, wherein f′ is the first derivative of the activation function, and y⁽ⁿ⁺¹⁾ⱼ is the comparison training value for the j-th node of the output layer 530.

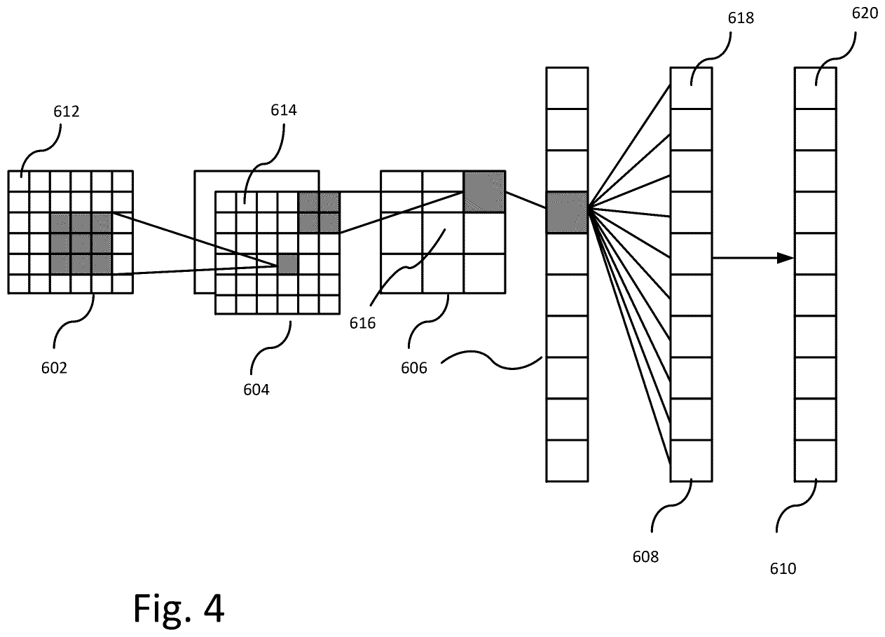

FIG. 4 shows a convolutional neural network 600, in accordance with one or more embodiments. Machine learning networks described herein, such as, e.g., the GAN, the autoencoder, the unrolled networks, etc. may be implemented using convolutional neural network 600.

In the embodiment shown in FIG. 4, the convolutional neural network includes 600 an input layer 602, a convolutional layer 604, a pooling layer 606, a fully connected layer 608, and an output layer 610. Alternatively, the convolutional neural network 600 may include several convolutional layers 604, several pooling layers 606, and several fully connected layers 608, as well as other types of layers. The order of the layers may be chosen arbitrarily, usually fully connected layers 608 are used as the last layers before the output layer 610.

In particular, within a convolutional neural network 600, the nodes 612-620 of one layer 602-610 may be considered to be arranged as a d-dimensional matrix or as a d-dimensional image. In particular, in the two-dimensional case the value of the node 612-620 indexed with i and j in the n-th layer 602-610 may be denoted as x⁽ⁿ⁾_{[i,j]}. However, the arrangement of the nodes 612-620 of one layer 602-610 does not have an effect on the calculations executed within the convolutional neural network 600 as such, since these are given solely by the structure and the weights of the edges.

In particular, a convolutional layer 604 is characterized by the structure and the weights of the incoming edges forming a convolution operation based on a certain number of kernels. In particular, the structure and the weights of the incoming edges are chosen such that the values x⁽ⁿ⁾ₖ of the nodes 614 of the convolutional layer 604 are calculated as a convolution x⁽ⁿ⁾ₖ=Kₖ*x⁽ⁿ⁻¹⁾ based on the values x⁽ⁿ⁻¹⁾ of the nodes 612 of the preceding layer 602, where the convolution * is defined in the two-dimensional case as:

$${x}_{k}^{( n )} [ i , j ] = ( {K}_{k} * {x}^{( n - 1 )} ) [ i , j ] = {\sum }_{{i}^{′}} {\sum }_{{j}^{′}} {K}_{k} [ {i}^{′} , {j}^{′} ] \cdot {x}^{( n - 1 )} [ i - {i}^{′} , j - {j}^{′} ] .$$

Here the k-th kernel Kₖ is a d-dimensional matrix (in this embodiment a two-dimensional matrix), which is usually small compared to the number of nodes 612-618 (e.g. a 3×3 matrix, or a 5×5 matrix). In particular, this implies that the weights of the incoming edges are not independent, but chosen such that they produce said convolution equation. In particular, for a kernel being a 3×3 matrix, there are only 9 independent weights (each entry of the kernel matrix corresponding to one independent weight), irrespectively of the number of nodes 612-620 in the respective layer 602-610. In particular, for a convolutional layer 604, the number of nodes 614 in the convolutional layer is equivalent to the number of nodes 612 in the preceding layer 602 multiplied with the number of kernels.

If the nodes 612 of the preceding layer 602 are arranged as a d-dimensional matrix, using a plurality of kernels may be interpreted as adding a further dimension (denoted as “depth” dimension), so that the nodes 614 of the convolutional layer 604 are arranged as a (d+1)-dimensional matrix. If the nodes 612 of the preceding layer 602 are already arranged as a (d+1)-dimensional matrix including a depth dimension, using a plurality of kernels may be interpreted as expanding along the depth dimension, so that the nodes 614 of the convolutional layer 604 are arranged also as a (d+1)-dimensional matrix, wherein the size of the (d+1)-dimensional matrix with respect to the depth dimension is by a factor of the number of kernels larger than in the preceding layer 602.

The advantage of using convolutional layers 604 is that spatially local correlation of the input data may exploited by enforcing a local connectivity pattern between nodes of adjacent layers, in particular by each node being connected to only a small region of the nodes of the preceding layer.

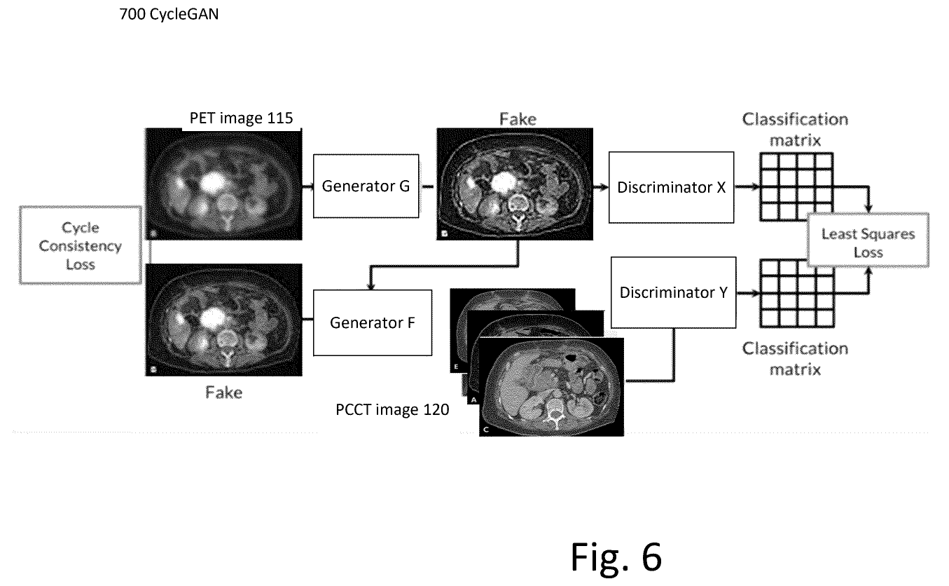

In embodiment shown in FIG. 6, the input layer 602 includes 36 nodes 612, arranged as a two-dimensional 6×6 matrix. The convolutional layer 604 includes 72 nodes 614, arranged as two two-dimensional 6×6 matrices, each of the two matrices being the result of a convolution of the values of the input layer with a kernel. Equivalently, the nodes 614 of the convolutional layer 604 may be interpreted as arranges as a three-dimensional 6×6×2 matrix, wherein the last dimension is the depth dimension.

A pooling layer 606 may be characterized by the structure and the weights of the incoming edges and the activation function of its nodes 616 forming a pooling operation based on a non-linear pooling function f. For example, in the two dimensional case the values x⁽ⁿ⁾ of the nodes 616 of the pooling layer 606 may be calculated based on the values x⁽ⁿ⁻¹⁾ of the nodes 614 of the preceding layer 604 as

$${x}^{( n )} [ i , j ] = f ( {x}^{( n - 1 )} [ {id}_{1} , {jd}_{2} ] , … , {x}^{( n - 1 )} [ {id}_{1} + {d}_{1} - 1 , {jd}_{2} + {d}_{2} - 1 ] )$$

In other words, by using a pooling layer 606, the number of nodes 614, 616 may be reduced, by replacing a number d1·d2 of neighboring nodes 614 in the preceding layer 604 with a single node 616 being calculated as a function of the values of said number of neighboring nodes in the pooling layer. In particular, the pooling function f may be the max-function, the average or the L2-Norm. In particular, for a pooling layer 606 the weights of the incoming edges are fixed and are not modified by training.

The advantage of using a pooling layer 606 is that the number of nodes 614, 616 and the number of parameters is reduced. This leads to the amount of computation in the network being reduced and to a control of overfitting.

In the embodiment shown in FIG. 6, the pooling layer 606 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

A fully-connected layer 608 may be characterized by the fact that a majority, in particular, all edges between nodes 616 of the previous layer 606 and the nodes 618 of the fully-connected layer 608 are present, and wherein the weight of each of the edges may be adjusted individually.

In this embodiment, the nodes 616 of the preceding layer 606 of the fully-connected layer 608 are displayed both as two-dimensional matrices, and additionally as non-related nodes (indicated as a line of nodes, wherein the number of nodes was reduced for a better presentability). In this embodiment, the number of nodes 618 in the fully connected layer 608 is equal to the number of nodes 616 in the preceding layer 606. Alternatively, the number of nodes 616, 618 may differ.

A convolutional neural network 600 may also include a ReLU (rectified linear units) layer or activation layers with non-linear transfer functions. In particular, the number of nodes and the structure of the nodes contained in a ReLU layer is equivalent to the number of nodes and the structure of the nodes contained in the preceding layer. In particular, the value of each node in the ReLU layer is calculated by applying a rectifying function to the value of the corresponding node of the preceding layer.

The input and output of different convolutional neural network blocks may be wired using summation (residual/dense neural networks), element-wise multiplication (attention) or other differentiable operators. Therefore, the convolutional neural network architecture may be nested rather than being sequential if the whole pipeline is differentiable.

In particular, convolutional neural networks 600 may be trained based on the backpropagation algorithm. For preventing overfitting, methods of regularization may be used, e.g. dropout of nodes 612-620, stochastic pooling, use of artificial data, weight decay based on the L1 or the L2 norm, or max norm constraints. Different loss functions may be combined for training the same neural network to reflect the joint training objectives. A subset of the neural network parameters may be excluded from optimization to retain the weights pretrained on another datasets.

In an embodiment, the machine learning network 110 is trained using a generative adversarial process. FIG. 5 displays a data flow diagram according to an embodiment for using a generative adversarial network for creating high resolution images based on input data that is indistinguishable from real output data. A generative adversarial model (also referred to as a generative adversarial network or GAN) includes a generative function 320 and a discriminative function 310, wherein the generative function 320 creates synthetic data, and the discriminative function 310 distinguishes between synthetic and real data. By training the generative function 320 and/or the discriminative function 310 on the one hand the generative function 320 is configured to create synthetic data which is incorrectly classified by the discriminative function 320 as real, on the other hand the discriminative function 310 is configured to distinguish between real data and synthetic data generated by the generative function. In the notion of game theory, a generative adversarial model can be interpreted as a zero-sum game. The training of the generative function and/or of the discriminative function is based, in particular, on the minimization of a cost function. The GAN is trained on a dataset of paired input images 115, 120 and their corresponding fused or higher resolution images that server as ground truth. The generator network 310 is trained to produce a fused image similar to the ground truth fused or a higher resolution image, while the discriminator network 320 is trained to distinguish between real and fake images. The loss function used during training may be a combination of adversarial and content loss to ensure that the fused or higher resolution image is realistic and preserves the most relevant information from the input images.

In an embodiment, the machine learning network 110 is or includes a Cycle-Consistent Adversarial Network, also referred to a CycleGAN. FIG. 6 depicts an example of a CycleGAN. In FIG. 6, there are two generators G and F and two discriminators X and Y. The generator G translates the distribution from one input X to another input Y, so that the discriminator Y cannot distinguish the transformed output Y=G (X) from the original input Y. One problems with this system is that the generator may translate all the images in the same way, so it can only generate a single example Y, which is not the desired task. To alleviate this problem, the CycleGAN structure uses a constraint by defining another generator F whose role is to be the inverse transform of G. This guarantees that the transformation of X will not be reduced to a single example. A new loss function characterizing cycle consistency loss is added during training, encouraging transformations to verify the properties FGX≈X and that G (FY)≈Y. There are two discriminators: Discriminator Y that discriminates generated Y from Y and Discriminator X which discriminates the generated X from real X. The cycle-consistency loss is separated into two distinct pieces, the first (1) corresponding to the loss between the elements of X and their reconstructions and the second (2) corresponding to the loss between the elements of Y and their reconstructions. During training, the generators and discriminators optimize the same general loss function, which is made up of two loss sub-functions associated with the generators (adversarial loss): which will be maximized by the discriminators (so that they can distinguish generation from reality) and minimized by the generators, so that they can create examples that are increasingly indistinguishable from real data.

During training, an additional loss value, parameter, or step is used. In an example, a CycleGAN as described above includes an objective function to minimize a loss. The total loss may be separated into three parts, adversarial losses, each for both domains, and cycle consistency loss. The adversarial loss function used in CycleGAN is similar to that of a typical GAN. It involves setting an objective for the generator G to produce images G(x) that are visually similar to images from domain Y, while the discriminator Dy aims to differentiate between the generated samples G(x) and real samples y. The goal is to minimize this objective for G, while the adversary D attempts to maximize it. Additionally, a similar loss function is introduced for the mapping function F: Y→X and its discriminator Dx. For each image x from domain X, the image translation cycle should be able to bring x back to the original image (forward cycle consistency), i.e., x→G(x)→F (G(x))≈x. Similarly, for each image y from domain Y, G and F should also satisfy backward cycle consistency: y→F(y)→G (F(y))≈y. An additional loss value/function is added to the adversarial losses for either of the domains.

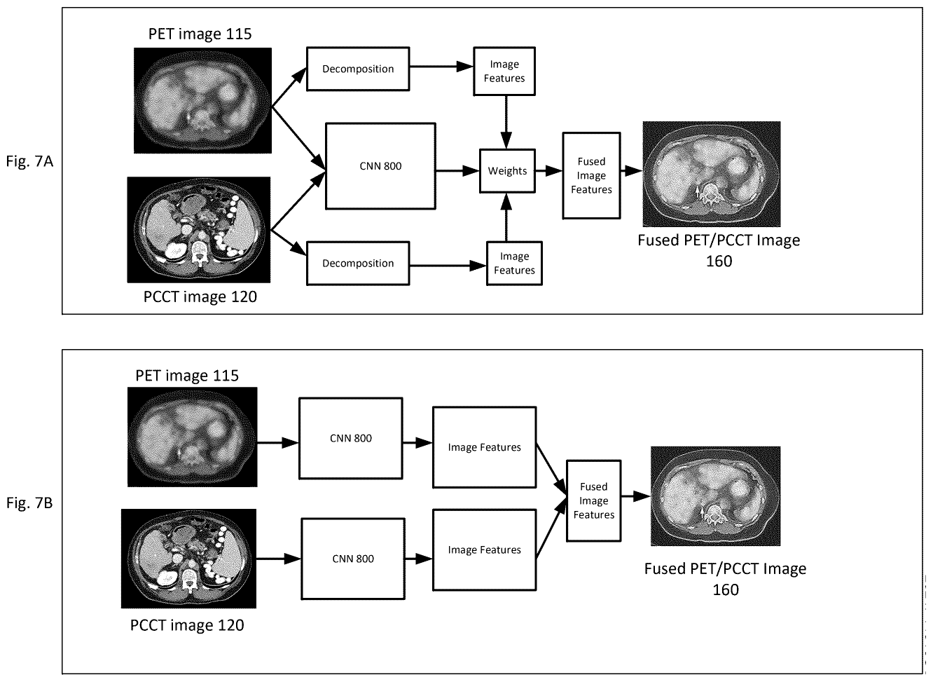

In an embodiment, the machine learning network 110 is or includes a CNN 800, for example as described above in FIG. 4. FIGS. 7A and 7B depict an example CCN 800 that can be used for generating a fused image. In a first example of FIG. 7A, a CNN 800 determines weights for how to fuse image features that are decomposed from the input images. The fused image features are used to generate the fused image. In a second example of FIG. 7B the image features are extracted by respective CNNs 800 and then fused to generate the fused image. The CNN 800 automatically learns spatial features from the input images, which can be used to create a fused or higher resolution representation by extracting the relevant information from the source image. The CNN 800 architecture is trained on a dataset of paired input images and their corresponding fused or higher resolution images. The loss function is used during training to ensure that the fused or higher resolution image preserves the most relevant information from the input images. Once the CNN 800 has been trained, it can fuse new pairs of input images or generate a new higher resolution image. The input images are fed through the CNN 800, and the resulting feature maps from each input modality are combined to create a fused or higher resolution representation.

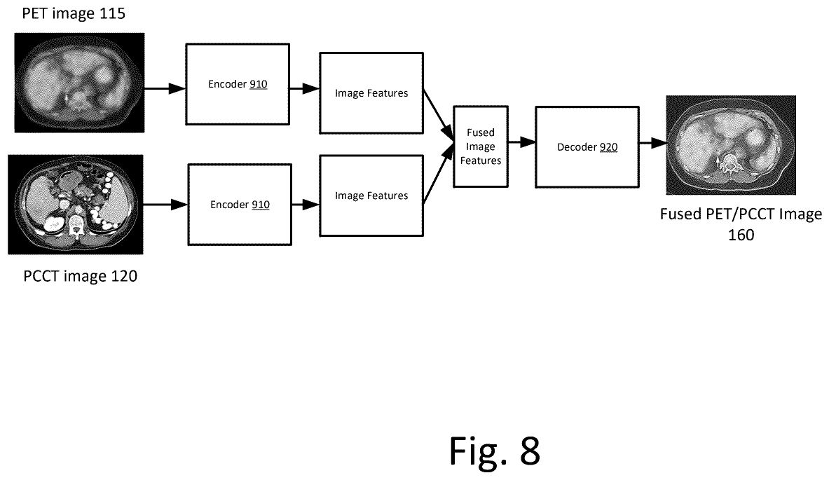

In an embodiment, the machine learning network 110 is or includes an auto-encoder. FIG. 8 depicts an example of a machine learning network 110 that includes an autoencoder. The auto-encoders may be used to perform feature-level fusion, where the input images are encoded into a lower-dimensional feature space and then decoded to create a fused representation. The auto-encoder is trained on a dataset of paired input images and their corresponding fused images. The loss function used during training typically combines mean squared error (MSE) and structural similarity index (SSIM) to ensure that the fused image preserves the most relevant information from the input images.

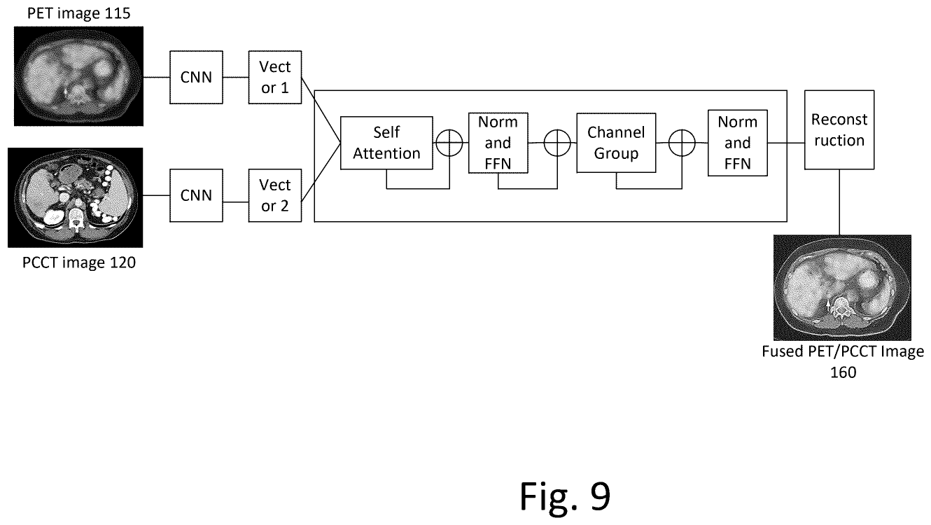

In an embodiment, the machine learning network 110 is or includes transformers. Attention mechanisms are used in image fusion to enable the model to focus on the most relevant features from each input modality. FIG. 9 depicts an example of a machine learning network 110 that uses transformers. CNNs are used to extract features from the input images which are then input into the transforms to determine which features are the most important for reconstructing the fused image. Different attention mechanisms may be used for fusion tasks. Self-attention mechanisms can compute attention scores for each feature map within a single modality. This allows the model to focus on the most informative regions within each modality and can improve the overall quality of the fused image. Cross-attention mechanisms can compute attention scores between different modalities. This allows the model to identify the most informative features from each modality and combine them in the fused image. Cross-attention can be especially useful when fusing images with different resolutions or sensor types. Multi-level attention mechanisms can be used to compute attention scores at multiple levels of abstraction. For example, the model could compute self-attention scores at the pixel level and higher levels of abstraction, such as object or scene level. This allows the model to capture fine-grained details and global context information in the fused image. Channel-wise attention mechanisms can compute attention scores for each channel within a single modality or between different modalities. This allows the model to identify the most informative channels and weigh them accordingly when fusing the input images.

In embodiments, the machine learning network 110 includes or is an unrolled iterative reconstruction that alternates gradient updates and regularization where a machine-learned network is provided for regularization through iteration sequences. Each given iteration either in an unrolled network or through a repetition of the reconstruction operations includes at least regularization. A gradient or comparison relating the image object to the measurements may be used. The gradient update uses a scaling factor that is determined based on scan settings or operator input. The scaling factor may relate to a gradient step size. In an embodiment, the scaling factor is determined based on a sampling pattern. In another embodiment, the scaling factor is determined based on a level of noise in the scan data. Regularization is provided in one, some, or all the iterations and can include the application of a machine learning network, for example a convolutional neural network (CNN).

The output of the processes and methods may be output for further processing or displayed to an operator. The image processing system 130 includes an operator interface 15, formed by an input and an output. The input may be an interface, such as interfacing with a computer network, memory, database, medical image storage, or other source of input data. The input may be a user input device, such as a mouse, trackpad, keyboard, roller ball, touch pad, touch screen, or another apparatus for receiving user input. The input may receive a scan protocol, imaging protocol, or scan parameters. An individual may select the input, such as manually or physically entering a value. Previously used values or parameters may be input from the interface. Default, institution, facility, or group set levels may be input, such as from memory to the interface.

The output may be a display device or any other type of interface. The images, for example, as output by the method are displayed. For example, an image of a region of the patient 225 is displayed. A generated image for a selected model and simulated scan is presented on a display of the operator interface 115. An analysis/interpretation may also be displayed on the display device. The image processing system 130 may be configured to generate a report/evaluation for the image that is displayed on the display device. The display is a CRT, LCD, plasma, projector, printer, or other display device. The display is configured by loading an image to a display plane or buffer. The display is configured to display the fused/higher resolution image of the region of the patient 225. The operator interface may include form a graphical user interface (GUI) enabling user interaction with the image processing system 130 and enables user modification in substantially real time.

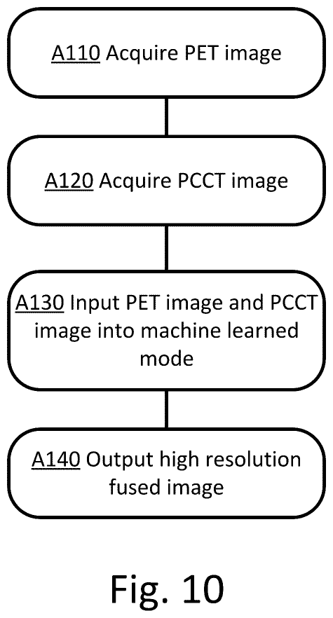

FIG. 10 depicts an example of a method for generation of high-resolution PET-CT images using high-res CT images and particularly PCCT images 120. The method utilizes the high-resolution capabilities of Photon Counting Computed Tomography (PCCT) within a PET/PCCT scanner setup to enhance the spatial resolution of PET images 115. This approach uses the high-res spatial data from PCCT to enhance the image quality of PET images 115 significantly. In an embodiment, Generative Adversarial Networks (GANs) are used. The GANs use existing high-resolution CT data from PCCT to enhance resolution of PET images 115, making this application of GAN specifically tailored to leverage real, applicable medical imaging data.

At act A110, a medical imaging device 105 acquires a PET image 115 of a region of a patient 225. Positron emission tomography (PET) scans capture images based on emissions from a radioactive substance administered to the patient 225.

At act A120, the medical imaging device 105 acquires a PCCT image 120 of the region of the patient 225. PCCT uses a crystal semiconductor material instead of a ceramic scintillator to directly generate an electric charge enabling high resolution while eliminating electronic noise, and with a reduced radiation dosage. Detected photons are counted individually, providing a more accurate image signal, and sorted according to their energy levels, enabling spectral discrimination at the detector level. The medical imaging device 105 is configured to acquire both the PET image 115 and PCCT image 120 in a single imaging session of a patient 225. In an embodiment, the medical imaging device 105 acquires data which is reconstructed to generate the PCCT image 120 and the PET image 115.

At act A130, the PET image 115 and the PCCT image 120 are input into a machine learning network, the machine learning network 110 trained to output high resolution PET-CT images. The machine learning network 110 is trained with real high-resolution PCCT and PET images 115. The resulting generated high-resolution PET images are both accurate and realistic, potentially reducing artifacts common in conventional methods.

In an embodiment, the machine learning network 110 includes or is a cycle-consistent adversarial network (cycle-GAN) that is based on paired PCCT and PET images 115 to produce an image. The cycle-GAN framework efficiently converts images between the source domain and the target domain when the underlying structures are similar. Additionally, cycle-GAN enforces an inverse transformation. This cycle consistency allows for higher accuracy levels than other machine learning-based methods because the model is doubly constrained. The cycle GAN model relies on continuous improvement of a generator network and a discriminator network. The accuracy of both networks is directly dependent on the design of their corresponding loss functions. In an embodiment a two-part loss function is used consisting of an adversarial loss and a cycle consistency loss.

Alternative models or networks such as CNNs, autoencoders, unrolled networks, or other generative networks may be used.

At act A140, the machine learning network 110 outputs a high resolution PET-CT image of the region of the patient 225. The image may be displayed to a user or further processed/analyzed.

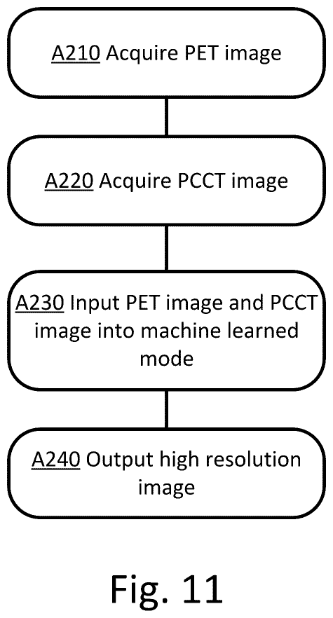

FIG. 11 depicts a method for generation of high-resolution fused PET-CT images using high-res CT images and particularly PCCT images 120. The method utilizes the high-resolution capabilities of Photon Counting Computed Tomography (PCCT) within a PET/PCCT scanner setup to enhance the spatial resolution of PET images 115. This approach uses the high-res spatial data from PCCT to enhance the image quality of PET images 115 significantly. In an embodiment, Generative Adversarial Networks (GANs) are used. The GANs use existing high-resolution CT data from PCCT to enhance resolution of PET images 115, making this application of GAN specifically tailored to leverage real, applicable medical imaging data.

At act A210, a medical imaging device 105 acquires a PET image 115 of a region of a patient 225. PET imaging is limited by poor spatial resolution (usually 4-5 mm) and noise. By integrating Photon Counting CT (PCCT), which offers superior resolution (up to 0.11 mm) and sensitivity, the embodiments improve the PET image 115 resolution, thereby enhancing disease detection, staging, and treatment monitoring. At act A220, the medical imaging device 105 acquires a PCCT image 120 of the region of the patient 225. The medical imaging device 105 is configured to acquire both the PET image 115 and PCCT image 120 in a single imaging session of a patient 225. In an embodiment, the medical imaging device 105 acquires data which is reconstructed to generate the PCCT image 120 and the PET image 115.

At act A230, the PET image 115 and the PCCT image 120 are input into a machine learning network, the machine learning network 110 trained to output high resolution fused PET-CT images. The machine learning network 110 may include or comprise models or networks such as CNNs, autoencoders, unrolled networks, GANs, or other generative networks.

At act A240, the machine learning network 110 outputs a high resolution fused PET-CT image of the region of the patient 225.

While the invention has been described above by reference to various embodiments, many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

The following is a list of non-limiting illustrative embodiments disclosed herein:

Illustrative embodiment 1. A method for generation of a high-resolution PET image, the method comprising: acquiring, by a medical imaging device, a PET image of a region of a patient; acquiring, by the medical imaging device, a PCCT image of the region of the patient; inputting the PET image and the PCCT image into a machine learning network, the machine learning network trained to output high resolution PET images that comprise a higher resolution than input PET images; and outputting the high-resolution PET image of the region of the patient.

Illustrative embodiment 2. The method of Illustrative embodiment 1, further comprising: displaying the high resolution PET image.

Illustrative embodiment 3. The method of a previous illustrative embodiment, wherein the machine learning network is trained using a generative adversarial process.

Illustrative embodiment 4. The method of Illustrative embodiment 3, wherein the machine learning network comprises a CycleGAN.

Illustrative embodiment 5. The method of a previous illustrative embodiment, wherein the machine learning network is trained using real PET and PCCT images.

Illustrative embodiment 6. The method of a previous illustrative embodiment, wherein the medical imaging device comprises a combined PET/PCCT imaging system configured to acquire the PET image and the PCCT image during a single imaging session.

Illustrative embodiment 7. The method of a previous illustrative embodiment, wherein the high resolution PET images include a resolution that is less than 1 mm.

Illustrative embodiment 8. A method for generation of fused high resolution PET-CT image from paired CT and PCCT images, the method comprising: acquiring, by a medical imaging device, a PET image of a region of a patient; acquiring, by the medical imaging device, a PCCT image of the region of the patient; inputting the PET image and the PCCT image into a machine learning network, the machine learning network trained to output high resolution PET-CT images that comprise a higher resolution than input PET images; and outputting the high resolution fused PET-CT image of the region of the patient.

Illustrative embodiment 9. The method of a previous illustrative embodiment, further comprising: displaying the high resolution fused PET-CT image.

Illustrative embodiment 10. The method of a previous illustrative embodiment, wherein the machine learning network is trained using a generative adversarial process.

Illustrative embodiment 11. The method of a previous illustrative embodiment, wherein the machine learning network comprises a CycleGAN.

Illustrative embodiment 12. The method of a previous illustrative embodiment, wherein the machine learning network is trained using real PET and PCCT images.

Illustrative embodiment 13. The method of a previous illustrative embodiment, wherein the medical imaging device comprises a combined PET/PCCT imaging system configured to acquire the PET image and the PCCT image during a single imaging session.

Illustrative embodiment 14. The method of a previous illustrative embodiment, wherein the high resolution fused PET-CT images include a resolution that is less than 1 mm.

Illustrative embodiment 15. A system for generation of a high resolution PET image from paired CT and PCCT images, the system comprising: a medical imaging device configured to acquire a PET image of a region of a patient and a PCCT image of the region of the patient; an image processing unit configured to input the PET image and the PCCT image into a machine learning network trained to generate high resolution PET-CT images that comprise a higher resolution than input PET images; and a display configured to display the high resolution PET-CT image generated from the PET image and the PCCT image.

Illustrative embodiment 16. The system of a previous illustrative embodiment, wherein the machine learning network is trained using a generative adversarial process.

Illustrative embodiment 17. The system of a previous illustrative embodiment, wherein the machine learning network comprises a CycleGAN.

Illustrative embodiment 18. The system of a previous illustrative embodiment, wherein the machine learning network is trained using real PET and PCCT images.

Illustrative embodiment 19. The system of a previous illustrative embodiment, wherein the medical imaging device comprises a combined PET/PCCT imaging system configured to acquire the PET image and the PCCT image during a single imaging session.

Illustrative embodiment 20. The system of a previous illustrative embodiment, wherein the high resolution PET-CT image includes a resolution that is less than 1 mm.

1. A method for generation of a high resolution PET image, the method comprising:
acquiring, by a medical imaging device, a PET image of a region of a patient;
acquiring, by the medical imaging device, a PCCT image of the region of the patient;
inputting the PET image and the PCCT image into a machine learning network, the machine learning network trained to output high resolution PET images that comprise a higher resolution than input PET images; and
outputting the high resolution PET image of the region of the patient.

2. The method of claim 1, further comprising:
displaying the high resolution PET image.

3. The method of claim 1, wherein the machine learning network is trained using a generative adversarial process.

4. The method of claim 3, wherein the machine learning network comprises a CycleGAN.

5. The method of claim 1, wherein the machine learning network is trained using real PET and PCCT images.

6. The method of claim 1, wherein the medical imaging device comprises a combined PET/PCCT imaging system configured to acquire the PET image and the PCCT image during a single imaging session.

7. The method of claim 1, wherein the high resolution PET images include a resolution that is less than 1 mm.

8. A method for generation of fused high resolution PET-CT image from paired CT and PCCT images, the method comprising:
acquiring, by a medical imaging device, a PET image of a region of a patient;
acquiring, by the medical imaging device, a PCCT image of the region of the patient;
inputting the PET image and the PCCT image into a machine learning network, the machine learning network trained to output high resolution PET-CT images that comprise a higher resolution than input PET images; and
outputting the high resolution fused PET-CT image of the region of the patient.

9. The method of claim 8, further comprising:
displaying the high resolution fused PET-CT image.

10. The method of claim 8, wherein the machine learning network is trained using a generative adversarial process.

11. The method of claim 9, wherein the machine learning network comprises a CycleGAN.

12. The method of claim 8, wherein the machine learning network is trained using real PET and PCCT images.

13. The method of claim 8, wherein the medical imaging device comprises a combined PET/PCCT imaging system configured to acquire the PET image and the PCCT image during a single imaging session.

14. The method of claim 8, wherein the high resolution fused PET-CT images include a resolution that is less than 1 mm.

15. A system for generation of a high resolution PET image from paired CT and PCCT images, the system comprising:
a medical imaging device configured to acquire a PET image of a region of a patient and a PCCT image of the region of the patient;
an image processing unit configured to input the PET image and the PCCT image into a machine learning network trained to generate high resolution PET-CT images that comprise a higher resolution than input PET images; and
a display configured to display the high resolution PET-CT image generated from the PET image and the PCCT image.

16. The system of claim 15, wherein the machine learning network is trained using a generative adversarial process.

17. The system of claim 16, wherein the machine learning network comprises a CycleGAN.

18. The system of claim 15, wherein the machine learning network is trained using real PET and PCCT images.

19. The system of claim 15, wherein the medical imaging device comprises a combined PET/PCCT imaging system configured to acquire the PET image and the PCCT image during a single imaging session.

20. The system of claim 15, wherein the high resolution PET-CT image includes a resolution that is less than 1 mm.
